(19) United States
(12) Patent Application Publication
(10) Pub. No.: US 2003/0215185 A1
(43) Pub. Date: Nov. 20, 2003

(54) Large diameter optical waveguide having long period grating therein

(75) Inventors: James S. Sirkis, Wallingford, CT (US); Trevor W. Macdougall, Simsbury, CT (US); Timothy J. Bailey, Longmeadow, MA (US); Mark R. Fernald, Enfield, CT (US); Martin A. Putnam, Cheshire, CT (US); Jerin Russell, Ellington, CT (US)

Correspondence Address: Ware, Fressola, Van Der Sluys & Adolphson LLP, 755 Main Street, P.O. Box 224, Monroe, CT, 06468, US

(73) Assignee: CiDRA Corporation,, Wallingford, CT (US)

(21) Appl. No.: 10/456,790

(22) Filed: Jun. 6, 2003

Related U.S. Application Data
(63) Continuation of application No. 09/455,865, filed on Dec. 6, 1999, now Pat. No. 6,519,388.
(60) Provisional application No. 60/387,186, filed on Jun. 7, 2002.

(51) Int. Cl. G02B 6/34

(52) U.S. Cl. 385/37

(57) ABSTRACT

A large diameter waveguide is provided having a diameter of at least about 0.3 millimeters, and an outer cladding with an inner core with a long period grating included therein. The long period grating either couples forward propagating cores modes to forward propagating cladding modes of one optical signal travelling in one direction in the large diameter waveguide, or couples forward propagating cladding modes to forward propagating cores modes of another optical signal travelling in another direction in the large diameter waveguide. The long period grating has an optical parameter that changes in response to an application of a compressive force on the optical waveguide. The outer cladding may also have the long period grating written therein. The long period grating has concatenated periodic or aperiodic gratings. The optical waveguide may be shaped like a dogbone structure having wider outer sections and a narrower central section inbetween. The long period grating is written in the narrower central section of the dogbone structure. The large diameter waveguide may be used in devices such as a tunable bandpass filter, connector or collimator.

### CROSS-REFERENCE TO RELATED APPLICATIONS

This application claims benefit to a provisional application serial No. 60/387,186, filed Jun. 7, 2002, which is a continuation application claiming benefit to application Ser. No. 455,865, filed Dec. 6, 1999 (CC-0078B), application serial No. 60/276,456, filed Mar. 16, 2001 (CC-0313), application Ser. No. 455,868, filed Dec. 6, 1999 (CC-0230), as well as application Ser. No. 10/098,890, filed Mar. 15, 2002 (CC-0438), which are all hereby incorporated by reference in their entirety.

### BACKGROUND OF THE INVENTION

1. Technical Field

The present invention generally relates to an optical component; and more particularly to an optical component having a long period grating written therein.

2. Description of Related Art

Optical fibers having long period gratings (LPG) are known in the art. The characteristics of long period gratings are shown and described in R. Kashyap, entitled “Fiber Bragg Gratings”, pages 171-178, as well as Othonos et al., entitled “Fiber Bragg Gratings”, pages 142-143, 211-216 and 262-263. The primary difference between a Bragg grating and a long period grating is the effect created by the interaction of light with the periodic index modulation of the grating. While a Bragg grating causes a reflection (counter-propagation) of the fundamental mode of optical light travelling in the core of the optical fiber, which is tightly bound to the core, the long period grating is a transmission device which couples the energy of the fundamental mode of optical light travelling in the core into loosely-bound cladding modes of higher order that travel in the cladding of the optical fiber. Optical fiber having long period gratings have a variety of applications in telecommunications, including sensors, modulators, gain flattening, mode couplers, filters, switches, etc. See U.S. Pat. No. 6,058,226, issued to Starodubov, as well as an article by Starodubov et al., entitled “All-Fiber Bandpass Filter with Adjustable Transmission Using Cladding-Mode Coupling,” IEEE Photonics Technology Letters, Volume 10, No. 11, November 1998, both hereby incorporated by reference in its entirety.

However, in spite of their promise, the use of optical fibers having long period gratings suffer from several technical shortcomings. In general, their performance is extremely sensitive to the effective indices of the core and clad of the optical fiber. Even a greater problem is their sensitivity to the difference between these two values. This is evident when the grating is bent. The transmission spectra of the long period grating are highly (non-linearly) dependent on the bend radius of the fiber. In addition, since long period gratings couple forward propagating core modes to forward propagating cladding modes, the transmission spectra of the long period gratings are very sensitive to the refractive index of the surrounding medium, which itself is subject to environmental perturbations due to changes in moisture, temperature, chemical composition, etc. When creating any device using an optical fiber having one or more long period gratings to form a useful device, another major difficulty is the sensitivity of these cladding modes to external perturbations. In addition to perturbations such as bending of the waveguide, these perturbations can take many forms such as deformation of the cladding (such as radial compression), interfacing or contact of the cladding with other materials which tend to strip the energy of the cladding mode from the waveguide, etc.

In view of this, it would be desirable to provide for the use of long period gratings in a manner which would overcome the aforementioned shortcomings, problems and disadvantages.

### SUMMARY OF THE INVENTION

In its broadest sense, the present invention provides a large diameter optical waveguide having a diameter of at least about 0.3 millimeters, and an outer cladding surrounding an inner core with a long period grating therein. The long period grating is written in the inner core either for coupling forward propagating core modes to forward propagating cladding modes of an optical signal travelling in one direction in the large diameter waveguide, or for coupling forward propagating cladding modes to forward propagating core modes of another optical signal travelling in another direction in the large diameter waveguide.

The long period grating has an optical parameter that changes in response to an application of a compressive force on the optical waveguide. The long period grating may include a plurality of concatenated periodic or aperiodic gratings. The inner core may only have the long period grating written therein, or a combination of the inner core and the cladding may have the long period grating therein. The optical waveguide may be shaped like a dogbone structure having wider outer sections and a narrower central section inbetween. The long period grating is written in the narrower central section of the dogbone structure. The narrower central section may have a tapered shape, including linear, quadratic or step-like tapering. The narrower intermediate section may also have a thermal device wrapped around the narrower central section of the optical waveguide to tune the center wavelength of the long period grating along a desired spectral range.

The large diameter waveguide having the long period grating therein and the compression-based tuning approach for tuning the same will open up a whole new host of optical coupling applications, optical attenuating applications, as well as parameter sensing applications and optical signal filtering applications not otherwise possible when using the prior art 125 micron tension-based tuned optical fiber.

In effect, the present invention is based on the glass collapse and/or cane grating concept developed by the assignee of the present patent application. In this case, the standard short-period Bragg grating having a periodicity of in a range of 1-2 micron is replaced by the long period grating having a periodicity of in a range of 20-900 microns. Increasing the diameter of the cladding adds rigidity and therefore prevents bending induced spectral distortion. The larger diameter also displaces the surrounding environment further from the core, which can be utilized to reduce the influence of environmental refractive index on the long period grating spectrum. The increase in cladding size can also add a smoother wavelength resonance in the spectral profile of the grating. The refractive index profile in the cladding can be modified to better confine the cladding modes so that they remain sufficiently far from the outer surface of the long period grating.

In one particular application, a tunable bandpass filter can be configured using a pair of long period gratings separated at an appropriate distance to provide maximum out-coupling of the fundamental to cladding mode (first long period grating) followed by maximum cladding mode to fundamental mode in-coupling (second long period grating). By inserting a core block between the two gratings, all wavelengths that are not coupled would be scattered. Thus, the tunable bandpass filter would pass only a selected band of wavelengths determined by the design of the long period gratings.

In still another application, a glass rod collimator can be configured having a large diameter waveguide with a long period grating written therein that couples light into one of the lower order modes of the cladding. Light exiting the large diameter waveguide in a low order mode would have very small divergence. In contrast, collimators known in the art typically have light exiting a core of a typically 125 micron optical fiber with a very high divergence. The collimator of the present invention is easy to manufacture and, being all glass, is stable over a large temperature range.

In effect, the invention provides one way to reduce and nearly eliminate the perturbation effects of bending by using a very rigid large diameter waveguide for many grating devices. By controlling the index of refraction of the various other sleeves applied to build up the diameter of the large diameter waveguide or an applied coating to the cladding, the region where the cladding mode would propagate is enhanced in efficiency. Additionally, other types of perturbations are exploited to control the properties of the cladding mode such as radial compression to vary the propagation efficiency, or the amount of light allowed to pass the control region.

The foregoing and other objects, features and advantages of the present invention will become more apparent in light of the following detailed description of exemplary embodiments thereof.

### BRIEF DESCRIPTION OF THE DRAWING

The drawing, not drawn to scale, include the following Figures:

FIG. 1 is a side view of a large diameter optical waveguide having a long period grating written therein in accordance with the present invention.

FIG. 2a is a side view of another embodiment of a large diameter optical waveguide having a long period grating written therein in accordance with the present invention.

FIG. 2b is a side view of another embodiment of a large diameter optical waveguide having a plurality of concatenated long period Bragg gratings written therein in accordance with the present invention.

FIG. 3 is a cross-sectional view of an athermal device having an optical waveguide therein similar to that shown in FIG. 2a in accordance with the present invention.

FIG. 4 is a side view of a tunable device having a positional/force feedback control circuit with an optical waveguide therein similar to that shown in FIG. 2a in accordance with the present invention.

FIG. 5(a) is a diagram of a variable attenuator in accordance with the present invention.

FIG. 5(b) is a diagram of a tunable bandpass filter in accordance with the present invention.

FIG. 6(a) is a diagram of a tunable bandpass filter in accordance with the present invention.

FIG. 6(b) is three graphs showing the operation of tunable bandpass filter in FIG. 6(a).

FIG. 7(a) is a diagram of a tunable bandpass filter in accordance with the present invention.

FIG. 7(b) is three graphs showing the operation of tunable bandpass filter in FIG. 7(a).

FIG. 8(a) is a diagram of a dual core optical device for adding an optical signal in accordance with the present invention.

FIG. 8(b) is a diagram of a dual core optical device for dropping an optical signal in accordance with the present invention.

FIG. 9 is a diagram of a multi-core optical sensing device in accordance with the present invention.

FIG. 10 includes FIGS. 10a, 10b, 10c; and FIG. 10a is a side view of another embodiment of an optical waveguide having a tapered central section with a long period grating written therein in accordance with the present invention; FIG. 10b is a side view of another embodiment of an optical waveguide having a quadratically tapered central section with a long period grating written therein in accordance with the present invention; and FIG. 10c is a side view of another embodiment of an optical waveguide having a step-like tapered central section with a long period grating written therein in accordance with the present invention.

FIG. 11 is a diagram of a collimator in accordance with the present invention.

FIG. 12 is a diagram of a connector in accordance with the present invention.

### BEST MODE FOR CARRYING OUT THE INVENTION

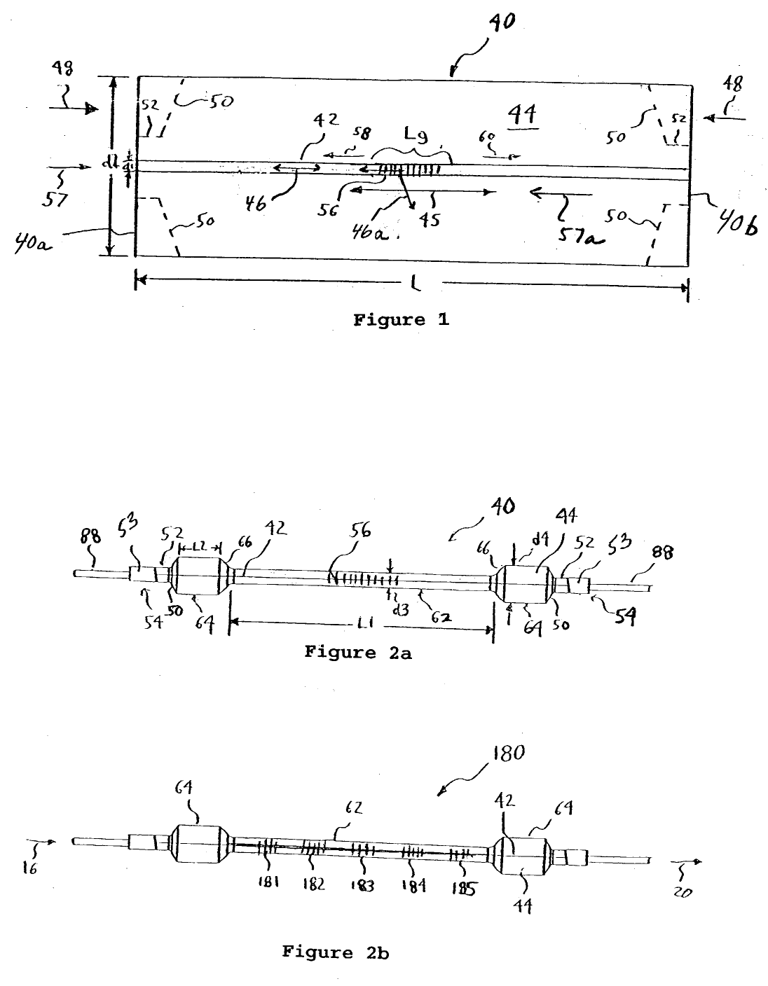

### FIG. 1: The Basic Invention

FIG. 1 shows a large diameter optical waveguide 40 having an outer cladding 44 surrounding an inner core 42, opposing ends 40a, 40b, and a diameter d2 of at least about 0.3 millimeters, similar to that disclosed in the aforementioned co-pending U.S. patent application Ser. No. 09/455,868 (CC-0230). The inner core 42 has a long period grating 56 written therein in relation to a longitudinal axis of the inner core 42 either for coupling forward propagating core modes in the inner core 42 (as generally indicated by arrow 46) to forward propagating cladding modes in the cladding 44 (as generally indicated by arrow 45) of an optical signal 57 travelling in one direction in the large diameter waveguide 40, or for coupling forward propagating cladding modes in the cladding 44 (as generally indicated by arrow 45) to forward propagating core modes in the core 42 (as generally indicated by arrow 46) of an optical signal 57a travelling in the other direction in the large diameter waveguide 40. The line 46a generally indicates the coupling of optical light from the core 42 to the cladding 44, and the cladding 44 to the core 42.

The long period grating 56 has a periodicity in a range of about 20-900 microns, which is substantially greater than the periodicity of a typical short period Bragg grating having a periodicity in a range of about 1-2 microns (about 20 or substantially more times shorter).

The long period grating 56 has an optical parameter and may be tuned by applying a compressive force indicated by arrows 48 on opposite ends of the optical waveguide 40, as well as by radial compression not shown.

### The Large Diameter Optical Waveguide Structure

The large diameter optical waveguide 40 comprises silica glass (SiO₂) based material having the appropriate dopants, as is known, to allow light indicated by arrow 45 to propagate in either direction along the inner core 42 and/or within the large diameter optical waveguide 40. The inner core 42 has an outer dimension d1 and the large diameter optical waveguide 40 has an outer dimension d2. Other materials for the large diameter optical waveguide 40 may be used if desired. For example, the large diameter optical waveguide 40 may be made of any glass, e.g., silica, phosphate glass, or other glasses; or solely plastic.

The outer dimension d2 of the outer cladding 44 is at least about 0.3 millimeters; and the outer dimension d1 of the inner core 42 is such that it propagates only a few spatial modes (e.g., less than about 6). For example, for single spatial mode propagation, the inner core 42 has a substantially circular transverse cross-sectional shape with a diameter d1 less than about 12.5 microns, depending on the wavelength of light. The invention will also work with larger or non-circular cores that propagate a few (less than about 6) spatial modes, in one or more transverse directions. The outer diameter d2 of the outer cladding 44 and the length L have values that will resist buckling when the large diameter optical waveguide 40 is placed in axial compression as indicated by the arrows 48.

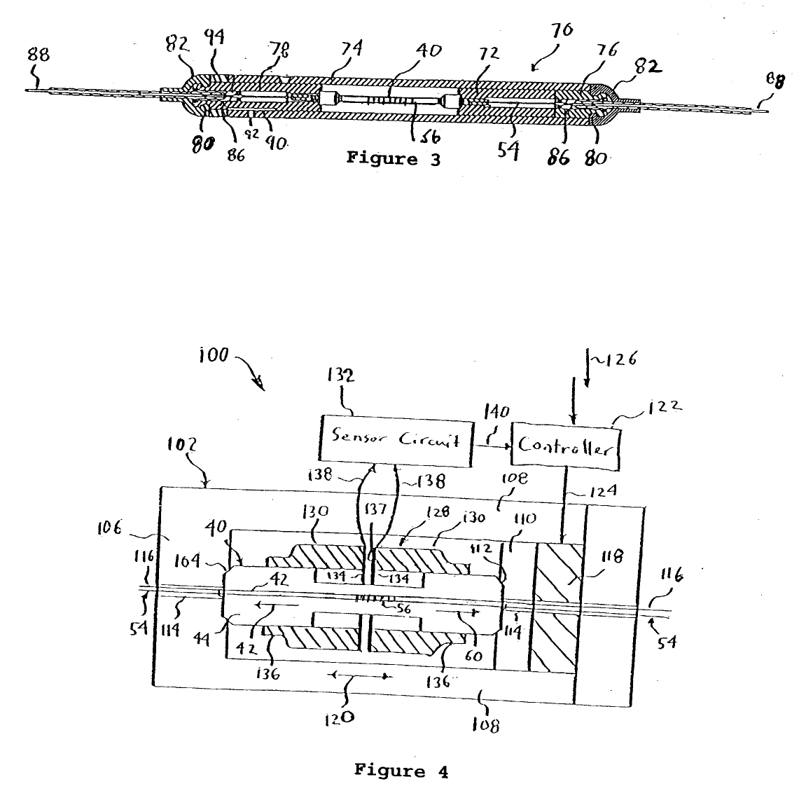

The large diameter optical waveguide 40 may be ground or etched to provide tapered (or beveled or angled) outer corners or edges 50 to provide a seat for the large diameter optical waveguide 40 to mate with another part (See FIG. 3) and/or to adjust the force angles on the large diameter optical waveguide 40, or for other reasons. The angle of the beveled corners 50 is set to achieve the desired function. Further, the large diameter optical waveguide 40 may be etched or ground to provide nubs 52 for an attachment of a pigtail assembly 54 (see FIG. 2a) to the large diameter optical waveguide 40. Further, the size of the large diameter optical waveguide 40 has inherent mechanical rigidity that improves packaging options and reduces bend losses.

The large diameter optical waveguide 40 has the long period grating 56 impressed (or embedded or imprinted) therein. The long period grating 56, as is known, is a periodic or aperiodic variation in the effective refractive index and/or effective optical absorption coefficient of an optical waveguide, such as that described in U.S. Pat. Nos. 4,725,110 and 4,807,950, entitled “Method for Impressing Gratings Within Fiber Optics”, to Glenn et al; and U.S. Pat. No. 5,388,173, entitled “Method and Apparatus for Forming Aperiodic Gratings in Optical Fibers”, to Glenn, which are all hereby incorporated by reference to the extent necessary to understand the present invention. The aperiodic variation of the long period grating 56 may include a chirped grating. See also U.S. Pat. Nos. 5,042,897 and 5,061,032, both issued to Meltz et al, and also hereby incorporated by reference in their entirety. As shown, the long period grating 56 is written in the inner core 42; however, the scope of the invention is intended to include writing the grating in the outer cladding 44, as well as a combination of the inner core 42 and the outer cladding 44. Any type of wavelength-tunable long period grating or reflective element embedded, etched, imprinted, or otherwise formed in the large diameter optical waveguide 40 may be used. The large diameter optical waveguide 40 may be photosensitive if the long period grating 56 are to be written into the large diameter optical waveguide 40. As used herein, the term long period “grating” means any of such transmissive elements. Further, the long period reflective element (or grating) 56 may be used in reflection and/or transmission of light, although it is typically used in transmission. The light 57 having a certain wavelength travelling in the core 42 incident on the long period grating 56 is coupled as indicated by a line 46a to the cladding 44, while the remaining incident light 57 (within a predetermined wavelength range) as indicated by a line 60 is not coupled to the cladding 44.

The long period grating 56 has a grating length generally indicated as Lg, which is determined based on the application, may be any desired length. A typical long period grating 56 has a grating length Lg in the range of about 3-40 millimeters. Other sizes or ranges may be used if desired. The length Lg of the long period grating 56 may be shorter than or substantially the same length as the length L of the large diameter optical waveguide 40. Also, the inner core 42 need not be located in the center of the large diameter optical waveguide 40 but may be located anywhere in the large diameter optical waveguide 40.

Accordingly, we have found that an outer diameter d2 of greater than about 400 microns (0.4 millimeters) provides acceptable results (without buckling) for a waveguide length L of 5 millimeters, over a grating wavelength tuning range of about 10 nanometers. For a given outer diameter d2, as the length L increases, the wavelength tuning range (without buckling) decreases. Other diameters d2 for the large diameter optical waveguide 40 may be used depending on the overall length L of the large diameter optical waveguide 40 and the desired amount of compression length change ΔL or wavelength shift Δλ.

The large diameter optical waveguide 40 may be made using fiber drawing techniques now known or later developed that provide the resultant desired dimensions for the core and the outer diameter discussed hereinbefore. As such, the external surface of the large diameter optical waveguide 40 will likely be optically flat, thereby allowing long period gratings to be written through the cladding similar to that which is done for conventional optical fiber. Because the large diameter optical waveguide 40 has a large outer diameter compared to that of a standard optical fiber (e.g., 125 microns), the large diameter optical waveguide 40 may not need to be coated with a buffer and then stripped to write the gratings, thereby requiring less steps than that needed for conventional optical fiber gratings. Also, the large outer diameter d2 of the large diameter optical waveguide 40 allows the waveguide to be ground, etched or machined while retaining the mechanical strength of the large diameter optical waveguide 40. Thus, the present invention is easily manufacturable and easy to handle. Also, the large diameter optical waveguide 40 may be made in long lengths (on the order of many inches, feet, or meters) then cut to size as needed for the desired application.

Also, the large diameter optical waveguide 40 does not exhibit mechanical degradation from surface ablation common with optical fibers under high laser fluency (or power or intensity) during grating exposure (or writing). In particular, the thickness of the cladding between the cladding outer diameter and the core outer diameter causes a reduced power level at the air-to-glass interface for a focused writing beam.

The large diameter optical waveguide 40 may have end cross-sectional shapes other than circular, such as square, rectangular, elliptical, clam-shell, octagonal, multi-sided, or any other desired shapes, discussed more hereinafter. Also, the waveguide may resemble a short “block” type or a longer “cane” type geometry, depending on the length of the waveguide and outer dimension of the waveguide.

### FIG. 2a: The Dogbone Shaped Structure

FIG. 2a shows a side cross-section of the outer surface of the large diameter optical waveguide 40, which may have a varying geometry depending on the application. For example, the large diameter optical waveguide 40 may have a “dogbone” shape with a narrower central section 62 and wider or larger outer sections 64. The dogbone shape may be used to provide increased sensitivity in converting axial force to length change ΔL and/or wavelength shift Δλ of the long period grating 56 and may be achieved by etching, grinding, machining, heating and stretching, or other known techniques.

The narrower central section 62 may have an outer diameter d3 of about 0.8-1 millimeter, and a length L of about 5-20 millimeter. The wider outer sections 64 each have a diameter d4 of about 3 millimeter and a length L2 of about 2-5 millimeter. The overall length L1 is about 10-30 millimeter and the multi-component grating has a length Lg of about 5-20 millimeter. Other lengths and diameters of the sections 62, 64 may be used. Other dimensions and lengths for the grating element 40 and the multi-component grating may be used.

An inner transition region 66 of the wider outer sections 64 may be a sharp vertical or angled edge or may be curved. A curved geometry has less stress risers than a sharp edge and thus may reduce the likelihood of breakage. Further, the wider outer sections 64 may have tapered (or beveled) outer corners 50.

We have found that such a dimension change between the dimension d4 of the wider outer sections 64 and the dimension d3 of the narrower central section 62 provides increased force to grating wavelength shift sensitivity (or gain or scale factor) by strain amplification. Also, the dimensions provided herein for the dogbone are easily scalable to provide the desired amount of sensitivity.

The dimensions and geometries for any of the embodiments described herein are merely for illustrative purposes and, as such, any other dimensions may be used if desired, depending on the application, size, performance, manufacturing requirements, or other factors, in view of the teachings herein.

The angle of the beveled corners 50 is set to achieve the desired function. In addition, one or both of the outer or axial ends of the large diameter optical waveguide 40 where a pigtail 53 of the pigtail assembly 54 attaches may have an outer tapered (or fluted, conical, or nipple) axial section 52.

Alternatively, the optical waveguide 40 may be formed by heating, collapsing and fusing a glass capillary tube to a fiber (not shown) by a laser, filament, flame, etc., as is described in the aforementioned co-pending U.S. patent application Ser. No. 09/455,865 (CC-0078B). Other techniques may be used for collapsing and fusing the tubes to the fiber, such as is discussed in U.S. Pat. No. 5,745,626, entitled “Method For And Encapsulation Of An Optical Fiber”, to Duck et al., and/or U.S. Pat. No. 4,915,467, entitled “Method of Making Fiber Coupler Having Integral Precision Connection Wells”, to Berkey, which are also incorporated herein by reference to the extent necessary to understand the present invention, or other techniques. Alternatively, other techniques may be used to fuse the fiber to the tube, such as using a high temperature glass solder, e.g., a silica solder (powder or solid), such that the fiber, the tube and the solder all become fused to each other, or using laser welding/fusing or other fusing techniques.

The long period grating 56 may be written in the inner core 42 before or after the capillary tube is encased around and fused to the fiber, such as described in the aforementioned co-pending U.S. patent application Ser. No. 09/455,865 (CC-0078B). If the long period grating 56 is written in the fiber after the tube is encased around the grating, the grating may be written through the tube into the fiber by any desired technique, such as is described in co-pending U.S. patent application Ser. No. 09/205,845 (CiDRA Docket No. CC-0130), entitled “Method and Apparatus For Forming A Tube-Encased Bragg Grating”, filed Dec. 4, 1998, which is incorporated herein by reference.

It is well known that the center wavelength at which a long period grating reflects may shift up or down due to the expansion or contraction of the large diameter optical waveguide 40, in response to the changes in temperature or other environmental factors. Thus, it is desirable to provide a tuning mechanism to compensate for a spectral shift due to change in temperature.

### FIG. 2b: Concatenated Periodic and/or Aperiodic Long Period Gratings

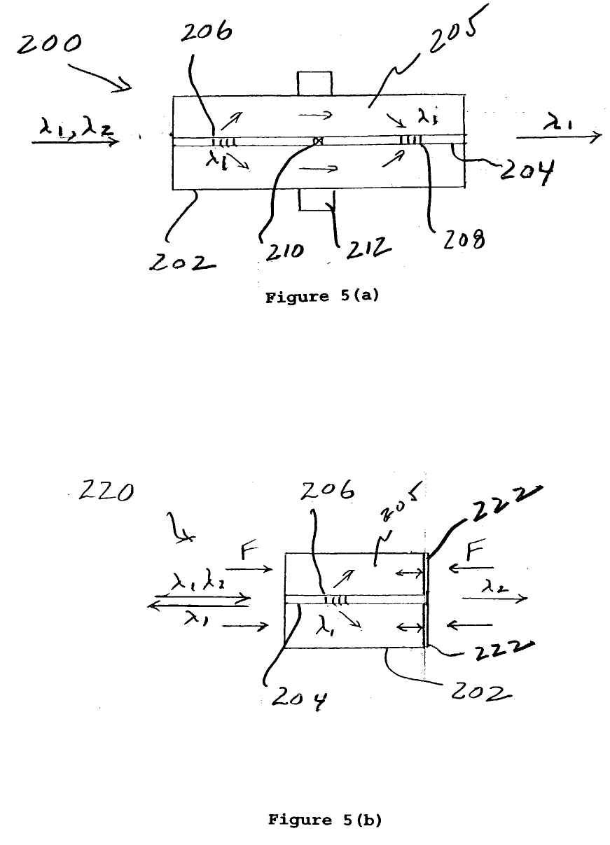

FIG. 2b shows a large diameter optical waveguide 180 having a plurality of concatenated periodic and/or aperiodic long period gratings 181, 182, 183, 184 and 185 spaced along the inner core 42 of the narrower central section 62, wherein each long period grating 181-185 is representative of a component of the Fourier series defining, for example, a desired grating profile. The long period gratings 181-185 are written into the inner core 42 at a normal angle relative to the axis of the core to reflect the optical signal into the outer cladding 44 of the large diameter optical waveguide 180 and pass the output signal 20. It is also contemplated by the present invention that the concatenated long period gratings 181-185 of FIG. 2b may be written in an optical waveguide having a non-uniform central section, similar to that described below in relation to FIGS. 5a, 5b, 5c.

### FIG. 3: The Athermal Device

FIG. 3 shows an athermal device 70 for compression-tuning the large diameter optical waveguide 40 to compensate for changes in temperature, which is similar to the athermal device described in U.S. patent Ser. No. 09/699,940 (CiDRA Docket No. CC-0234A), entitled “Temperature Compensated Optical Device”, which is incorporated herein by reference. The athermal device 70 includes the large diameter optical waveguide 40, attached pigtail assemblies 54, and a compensating spacer or rod 72, disposed in a tubular housing 74 formed of a high strength metal or metal alloy material, preferably having a low CTE that is higher than silica.

A fixed end cap 76 and an adjustable end cap 78, which are formed of similar material as the tubular housing are welded in respective ends of the tubular housing 74 to secure and maintain in axial alignment the optical waveguide and compensating spacer 72. Both the fixed end cap 76 and the adjustable end cap 78 extend outward from the end of the tubular housing 74, and include a circumferential groove 80 for receiving a respective strain relief boot 82. Further, the fixed end cap 76 and the adjustable end cap 78 include a bore for receiving a respective strain relief device 86 and for passing the optical fiber 88 of the pigtail assemblies 54 therethrough.

The compensating spacer or rod 72 is disposed between the fixed end cap 76 and the large diameter optical waveguide 40. The spacer 72 includes a stepped bore disposed axially for receiving the pigtail assembly 54 therethrough. The stepped bore has a diameter greater than the inner portion of the bore of the spacer to assure that no contact occurs between the spacer and the fiber during expansion and contraction of the athermal device 70.

The spacer 72 is formed of a metal or metal alloy, such as steel, stainless steel, aluminum, high expansion alloy. The CTEs and lengths of the large diameter optical waveguide 40, the end caps 76, 78 and the spacer 72 are selected such that the reflection wavelength of the long period grating 56 does not substantially change over a predetermined temperature range (i.e., 100° C.). More specifically, the length of the spacer 72 is sized to offset the upward grating wavelength shift due to temperature and the thermal expansion of the tubular housing, waveguide and end caps. As the temperature increases, the spacer length expands faster than the optical waveguide, which shifts the grating wavelength down to balance the intrinsic wavelength shift up with increasing temperature. The length of the adjustable end cap is longer than the fixed end cap 76.

Additionally, a pair of planar surfaces 90 are ground or formed in the outer surface of the adjustable end cap 78 to maintain the adjustable end cap in a fixed rotational orientation to the tubular housing 74 and large diameter optical waveguide 40, during adjustment and mechanical burn-in process. The planar surfaces 90 are spaced radially at a predetermined angle (e.g., 120 degrees) and extend axially a predetermined length (i.e., 0.290 in.) to permit axial movement while maintaining the adjustable end cap 78 rotationally fixed. The planar surface 90 align with a pair of holes 92 disposed in the tubular housing 74, which are radially spaced 120 degrees. The holes 92 in the tubular housing 74 receive a pair of spring loaded pins (not shown), which are disposed within a collar (not shown) mounted on the outer surface of the tubular housing during assembly. The pins extend through the holes 92 to engage the planar surfaces 90 of the adjustable end cap 78, while the collar temporarily clamps the tubular housing to the adjustable end cap, before being welded to the tubular housing 74.

To complete the assembly of the athermal device 70, a ring 94, having a width substantially equal to the distance between the end of the tubular housing 74 and the strain relief boot 82, is placed over the adjustable end cap 78. The strain relief boots 82, which are formed of a polymer (e.g., Santoprene), are then snap fit into respective grooves 80 of the end caps 76, 78.

For a discussion of packaging and athermalizing gratings, the reader is referred to U.S. Pat. Nos. 6,269,207 and 6,198,868, which are both hereby incorporated by reference.

### FIG. 4: Compression Tuning and Feedback Control

FIG. 4 shows a tuning device 100 that compresses axially the large diameter optical waveguide 40 using a non-optical closed control loop. The tuning device 100 is similar to that disclosed in co-pending U.S. patent application Ser. No. 09/707,084 entitled “Compression-Tuned Bragg Grating and Laser”, which is hereby incorporated herein by reference in its entirety, as well as the aforementioned co-pending U.S. patent application Ser. No. 09/455,868 (CC-0230).

The tuning device 100 compresses axially the large diameter optical waveguide 40 within a housing 102. One end of the large diameter optical waveguide 40 is pressed against a seat 104 in one end 106 of the housing 102. The housing also has a pair of arms (or sides) 108, which guide a movable block 110. The block 110 has a seat 112 that presses against the other end of the large diameter optical waveguide 40. The axial end faces of the large diameter optical waveguide 40 and/or the seats on mating surfaces 104, 112 may be plated with a material that reduces stresses or enhances the mating of the large diameter optical waveguide 40 with the seat on the mating surfaces. The ends of the housing 102 and the block 110 have a bore 114 drilled through them to allow the fiber 116 to pass therethrough. Instead of the recessed seats 104, 112, the end 106 of the housing 102 and the block 110 may provide a planar surface for engaging flush with the respective ends of the large diameter optical waveguide 40.

The housing 102 may be assembled such that a pre-strain or no pre-strain exists on the large diameter optical waveguide 40 prior to applying any outside forces.

An actuator 118, such as a piezoelectric actuator, engages the moveable block 110, which causes the block to move as indicated by arrows 120. Accordingly, the PZT actuator 118 provides a predetermined amount of force to the moving block 110 to compress the large diameter optical waveguide 40, and thereby tune the long period grating 56 to a desired reflection wavelength. In response to a control signal generated by a displacement control circuit or controller 122 via conductor 124, the PZT actuator 118 is energized to provide the appropriate compression force necessary to tune the grating element to the desired Bragg reflection wavelength of the long period grating 56. The control circuit 122 adjusts the expansion and retraction of the actuator 118 in response to an input command 126 and a displacement sensor 128 that provides feedback representative of the strain or compression of the large diameter optical waveguide 40 to form a non-optical closed-loop control configuration. In other words, light 57 propagating through the network or device is not used to provide feedback for the tuning of the long period grating 56.

In one embodiment, the displacement sensor 128 includes a pair of capacitive elements 130 and a known displacement sensor circuit 132, similar to that disclosed in co-pending U.S. patent application Ser. No. 09/519,802, entitled, “Tunable Optical Structure Featuring Feedback Control”, filed Mar. 6, 2000, which is incorporated by reference in its entirety. As shown in FIG. 4, each capacitive element 130 is generally tubular having an annular capacitive end surface 134. The capacitive elements may be formed of glass, plastic or other material. The capacitive elements 130 are mounted, such as welding or epoxy, to respective ends of the large diameter optical waveguide 40 at 136 such that the capacitive surfaces 134 are spaced a predetermined distance apart, for example, approximately 1-2 microns. Other spacings may be used if desired. The capacitive elements 130 may be bonded or secured using an epoxy or other adhesive compound, or fused to large diameter optical waveguide 40 using a CO₂ laser or other heating element. The capacitive surfaces 134 are coated with a metallic coating, such as gold, to form a pair of annular capacitive plates 137. The change in capacitance depends on the change in the spacing between the capacitive plates.

Electrodes 138 are attached to the capacitive plates 137 to connect the capacitor to the displacement sensor circuit 132. The sensor circuit 132 measures the capacitance between the capacitive plates 136 and provides a sensed signal 140, indicative of the measured capacitance, to the displacement controller 122. As the large diameter optical waveguide 40 is strained, the gap between the parallel capacitive plates 136 will vary, thereby causing the capacitance to change correspondingly. Specifically, as the grating is compressed, the gap between the capacitive plates 136 is reduced, resulting in an increase in capacitance. The change in capacitance is inversely proportional to the change in the reflection wavelength ë_{b} of the long period grating 56. Since the capacitive elements 130 are directly connected to the large diameter optical waveguide 40, the capacitive elements are passive and will not slip. One skilled in the art would be able to implement, without undue experimentation, the sensor electronics circuit 132 to measure the change in capacitance between the two capacitive plates 137.

In the operation of the tuning device 100, the controller 122 receives the wavelength input signal 126, which represents the desired reflection wavelength to tune the grating unit. In response to the input signal 126 and the sensed signal 140, which is representative of the present reflection wavelength of the long period grating 56, the controller 122 provides a control signal 124 to the actuator 118 to increase or decrease the compression force applied to the large diameter optical waveguide 40 to set the desired reflection wavelength of the long period grating 56. The change in applied force to the large diameter optical waveguide 40 changes the spacing between the ends of the long period grating 56, and therefore, the spacing between the capacitive plates 137. As described above, the change in spacing of the capacitive plates 136 changes the capacitance therebetween provided to the sensor circuit 132, which provides displacement feedback to the controller 122. While the sensor circuit 132 and the controller 122 has been shown as two separate components, one would recognize that the functions of these components may be combined into a single component. One example of a closed loop actuator 118 that may be used is Model No. CM (controller) and DPT-C-M (for a cylindrical actuator) made by Queensgate, Inc. of N.Y.

Although the invention has been described with respect to using a capacitor 128 to measure the gap distance, it should be understood by those skilled in the art that other gap sensing techniques may be used, such as inductive, optical, magnetic, microwave, time-of-flight based gap sensors. Moreover, the scope of the invention is also intended to include measuring or sensing a force applied on or about the compressive element, and feeding it back to control the compression tuning of the optical structure. While the embodiment of the present invention described hereinbefore includes means to provide feedback of the displacement of a large diameter optical waveguide 40, one should recognize that the tuning devices may be accurately and repeatably compressed and thus may operate in an open loop mode.

Alternatively, instead of using a piezoelectric actuator 118, the large diameter optical waveguide 40 may be compressed by another actuator, such as a solenoid, pneumatic force actuator, or any other device that is capable of directly or indirectly applying an axial compressive force on the large diameter optical waveguide 40. Further, a stepper motor or other type of motor whose rotation or position can be controlled may be used to compress the waveguide. A mechanical linkage connects the motor, e.g., a screw drive, linear actuator, gears, and/or a cam, to the movable block 110 (or piston), which cause the block to move as indicated by arrows 120, similar to that described in pending U.S. patent application Ser. No. 09/751,589 entitled “Wide Range Tunable Optical Filter”, filed Dec. 29, 2000 (CC-0274A); and U.S. patent application Ser. No. 09/752,332 entitled “Actuator Mechanism for Tuning an Optical Device”, filed Dec. 29, 2000. (CC-0322), which are incorporated herein by reference. The stepper motor may be a high resolution stepper motor driven in a microstepping mode, such as that described in the aforementioned U.S. Pat. No. 5,469,520, “Compression Tuned Fiber Grating”, to Morey et al, (e.g., a Melles Griot NANOMOVER), incorporated herein by reference.

Alternatively, the long period grating 56 may be tuned by mechanically stressing (i.e. tension, bending) the grating elements, or varying the temperature of the grating (i.e., using a heater), such as that described in U.S. Pat. No. 5,007,705, entitled “Variable Optical Fiber Bragg Filter Arrangement”, to Morey et al., which is incorporated herein by reference.

The scope of the invention is also intended to include other tunable bandpass filter embodiments.

### FIG. 5(a): The Variable Attenuator

For example, FIG. 5(a) shows a variable attenuator in accordance with the invention, in which one or more external perturbations can be applied to the waveguide to filter an optical signal. The external perturbations may include compression radially, as well as by bending or thermally, and by way of example is shown as a compression F in FIG. 5(a). The variable attenuator is generally indicated as 200 and has a large diameter optical waveguide 202 having an inner core 204, a cladding 205 surrounding the same, two long period gratings 206, 208, a core mode blocker 210 and a modulator or attenuator 212 or other external perturbation generator. The two long period gratings 206, 208 which are spaced at a predetermined distance and have a given wavelength such as λ₁ couple optical light between the core 204 and the cladding 206, as shown. In this region, almost any disturbance of the cladding, for example, by a compression force F or any perturbation generated, will cause loss for the cladding mode and thereby decrease transmission of the device. The core mode blocker 210 blocks or extinguishes the light having the other wavelengths such as λ₂ as shown. Embodiments are also envisioned in which an axial force may be applied on the variable attenuator to tune the center wavelength of the long period gratings 206, 208.

Although the embodiment disclosed herein using a core mode blocker, other embodiments are envisioned using two waveguides coupled with a free optics arrangement with the core blocked.

### FIG. 5(b): A Tunable Bandpass Filter

FIG. 5(b) shows a tunable bandpass filter generally indicated as 220 in accordance with the invention. Similar elements in FIGS. 5(a) and 5(b) have similar reference numerals. The tunable bandpass filter 220 has a reflective surface 222 on the cladding 205, or any coating on the end surface of the cane. The long period grating 206 couples optical light having a given wavelength such as λ₁ between the core 204 and the cladding 206, which is reflected off the reflective surface 222, re-coupled back into the core 204 and transmitted back out of the attenuator 200. The uncoupled light having the other wavelengths such as λ₂ as shown is not reflected and exits the end of the waveguide.

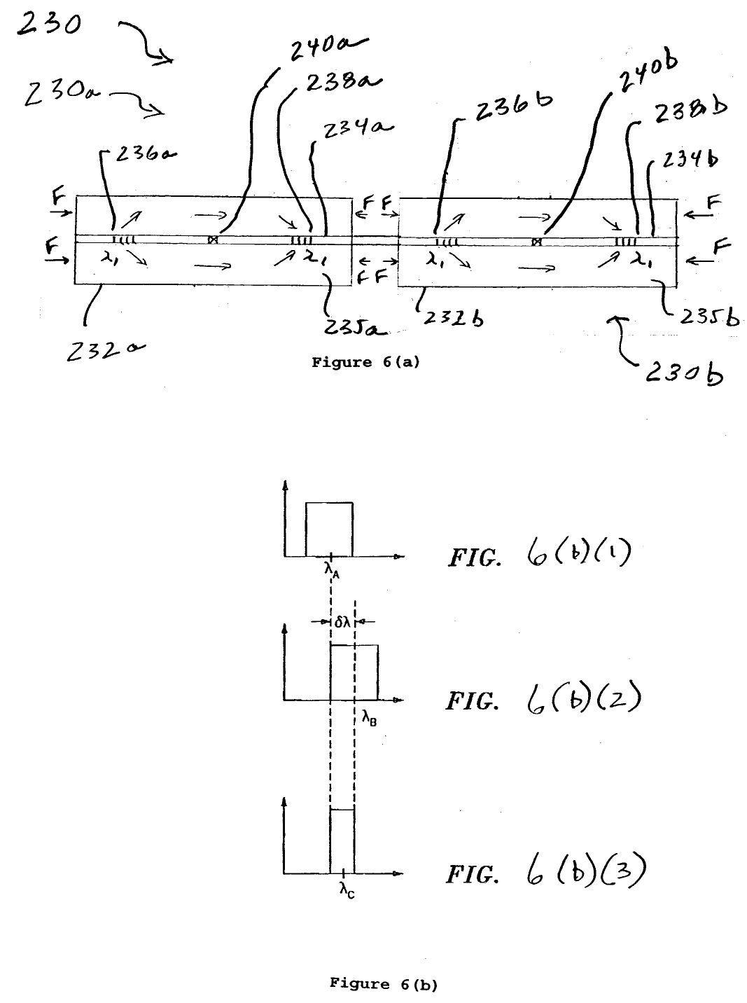

### FIG. 6(a): Variable Bandwidth Tunable Bandpass Filter

FIG. 6(a) shows a variable bandwidth tunable bandpass filter generally indicated as 230 having a pair of the tunable bandpass filter devices generally indicated as 230a, 230b similar to those described above, which includes large diameter optical waveguides 232a, 232b having inner cores 234a, 234b, claddings 235a, 235b surrounding the same, two long period gratings 236a, 236b, 238a, 238b having a given wavelength such as λ₁ as shown and core mode blockers 240a, 240b. The variable bandwidth filter 230 works by de-tuning one or both of the filters 230a, 230b. Similar to that discussed above, the long period gratings 236a, 236b, 238a, 238b couple optical light having the given wavelength such as λ₁ as shown between the cores 234a, 234b and the claddings 236a, 236b. The core mode blockers 240a, 240b block or extinguish light having the other wavelengths such as λ₂. In effect, the first tunable bandpass filter 230a provides a band of light to the second tunable bandpass filter 230b. If the first and second tunable bandpass filters 230a, 230b are tuned at the exact wavelength then the filtering functions would overlap, providing a wide filter function, but as either or both of the tunable bandpass filters are “de-tuned” by slightly tuning the center wavelength of one different from the other, the filter function is effectively narrowed changing the width of the filter function, which can be varied by tuning. In other words, the filters 230a, 230 are either separately or both tuned so there is less overlap to change the width of the filter function by changing the center wavelength of either or both filters 230a, 230b. The operation of this “de-tuning” technique is shown and described in more detail in patent application Ser. No. 09/648,525 (CC-0273), which is hereby incorporated by reference in its entirety. FIGS. 6(b)(1), (b)(2) and (b)(3) show the offsetting of the optical signal in relation to the center wavelength λ_{c}. In particular, FIG. 6(b)(1) illustrates the filter function of the tunable bandpass filter 230a; FIG. 6(b)(2) illustrates the filter function of the tunable bandpass filter 230b. FIG. 6(b)(3) illustrates the filter function of the overall tunable bandpass filter 230. Embodiments can also be envisioned that include the use of tuning devices that actuate multiple “dogbones” in parallel with a single actuator, in series using a single actuator or any combination of the two in multiple actuator designs.

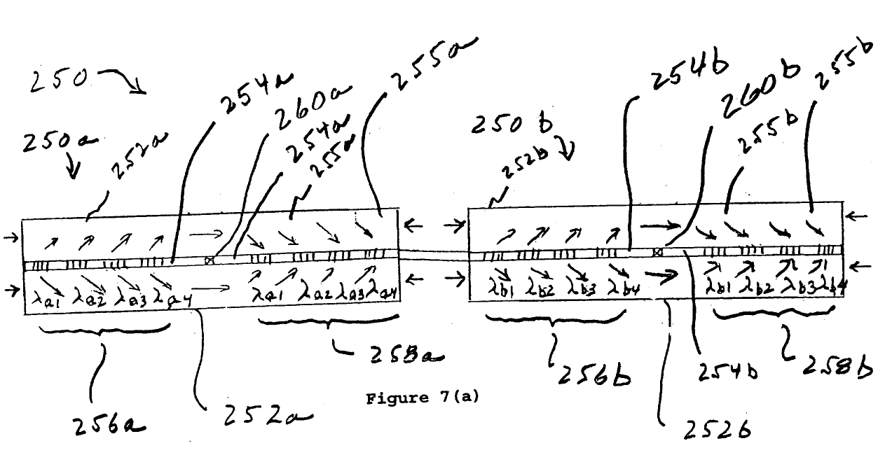

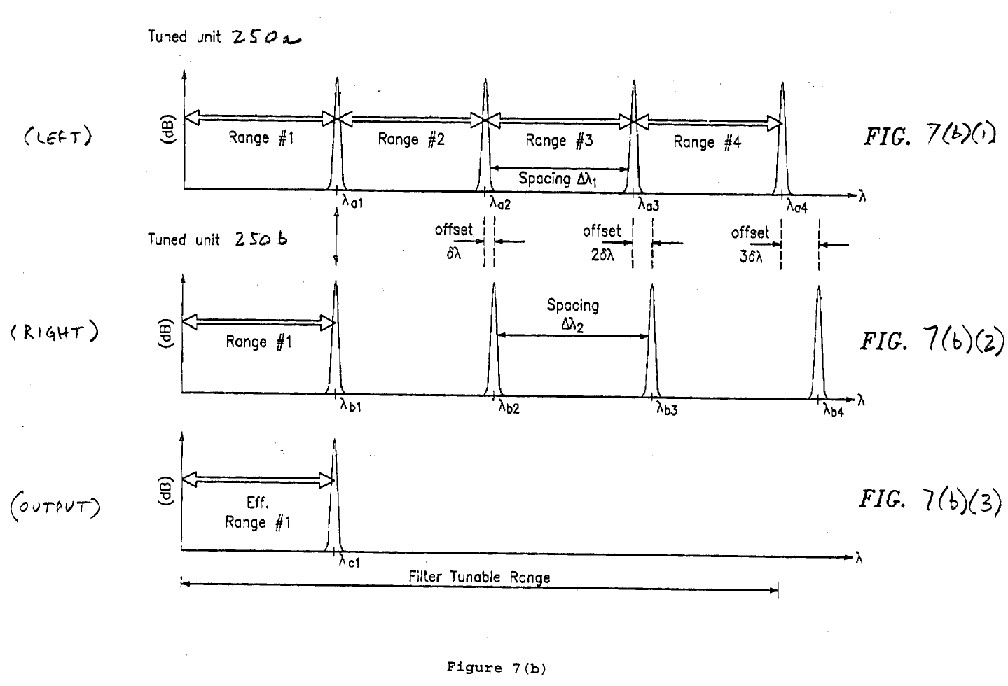

### FIG. 7(a): Tunable Bandpass Filter

FIG. 7(a) shows a tunable bandpass filter generally indicated as 250 in which co-located or concatenated long period gratings are used. The bandpass filter 250 has a pair of the tunable bandpass filter devices generally indicated as 250a, 250b similar to those described above, which includes large diameter optical waveguides 252a, 252b having inner cores 254a, 254b, claddings 255a, 255b surrounding the same, four groups of long period gratings 256a, 256b, 258a, 258b having given wavelengths such as λₐ₁-λₐ₄, λ_{b1}-λ_{b4} as shown, core mode blockers 260a, 260b. In FIG. 7(a), the two tunable bandpass filters 250a, 250b having the two or more co-located or concatenated long period gratings 256a, 256b, 258a, 258b that are comparable may be used together so that only one pair of gratings λₐ₁-λₐ₄, λ_{b1}-λ_{b4} will align at any given time. In operation, each tunable bandpass filter 250a, 250b may be tuned so that comparable center peaks in each filter align, for scanning across each respective wavelength ranges (i.e. Range No. 1-Range No. 4). With this approach, the Vernier effect is used to extend the range of the overall filter 250. FIG. 7(b) shows the filter functions of the filters 250a, 250b illustrating the relationships of the peaks of each filter function relative to each other with FIG. 7(b)(1) showing the filter function of the left filter 250a, FIG. 7(b)(2) showing the filter function of the right filter 250b, and FIG. 7(b)(3) showing the filter function of the overall tunable bandpass filter 250. The operation of this technique is shown and described in more detail in patent application Ser. No. 09/648,524 (CC-0274) and Ser. No. 09/751,589 (CC-0274A), which are hereby incorporated by reference in its entirety. Each pair of long period gratings is separated at an appropriate distance and may be used to provide maximum out-coupling of the fundamental to cladding mode (first LPG) followed by maximum cladding mode to fundamental mode in-coupling (second LPG). The core blocks 260a, 260b are inserted between the groups of gratings, all wavelengths that are not coupled would be extinguished. Thus, each bandpass filter 250a, 250b would pass only a selected band of wavelengths determined by the design of the long period gratings. The overall structural rigidity of the large diameter optical waveguides 252a, 252b provide the control of the cladding mode propagation that is discussed above. Additionally, one or both bandpass filter 250a, 250b is tunable using the aforementioned compression tuning techniques shown in FIG. 4.

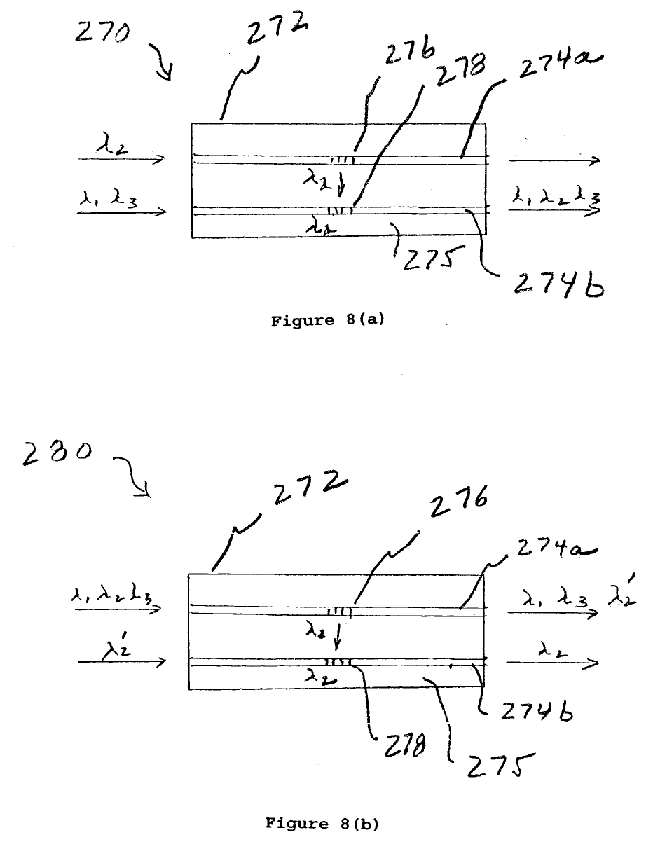

### FIG. 8(a): Dual (or Multi) Core Waveguide Coupler

FIG. 8(a) shows a dual (or multi) core waveguide coupler generally indicated as 270 for adding a wavelength from an optical signal and includes a large diameter optical waveguide 272 having two inner cores 274a, 27b, a cladding 275 surrounding the same, and two long period gratings 276, 278 having a given wavelength such as λ₂. The dual (or multi) core waveguide coupler 270 may be used to exploit the large mode field by allowing evanescent coupling from one core 274a to the other core 274b. In operation, an optical signal having a wavelength λ₂ is provided into the core 274a, and an optical signal having wavelengths λ₁, λ₃ is provided into the core 274b. The optical signal having the wavelength λ₂ is coupled from the core 274a to the core 274b. The optical signal provided from the core 274b includes wavelengths λ₁, λ₂, λ₃ as shown.

In comparison, FIG. 8(b) shows another dual (or multi) core waveguide coupler generally indicated as 280 for dropping a wavelength from an optical signal. Similar elements in FIGS. 8(a) and (b) are labelled with similar reference numerals. In operation, an optical signal having wavelengths λ₁, λ₂, λ₃ is provided into the core 274a. The optical signal having the wavelength λ₂ is coupled from the core 274a to the core 274b. The optical signal provided from the core 274a includes wavelengths λ₁, λ₃ as shown, while the optical signal provided from the core 274b includes wavelengths λ₂, as shown. The dual (or multi) core waveguide coupler also functions as a reconfigurable optical add/drop multiplexer (ROADM) when an optical signal having wavelengths λ₂′ is provided into the core 274b. In this case, the optical signal provided from the core 274a includes wavelengths λ₁, λ₃, λ₂′ as shown, The operation of this “coupling and tuning” technique is shown and described in more detail in patent application Ser. No. 10/098,925 (CC-0435), which is hereby incorporated by reference in its entirety.

Embodiments are also envisioned that include a coupler that allows tuning of the range where coupling is allowed by either radial or axial compression as well as bending or varying the index of refraction of the media surrounding the waveguide by methods such as thermal controls. This allows varying the wavelength range where coupling is allowed, the percent of the energy, which is allowed to propagate in each of the cores, etc.

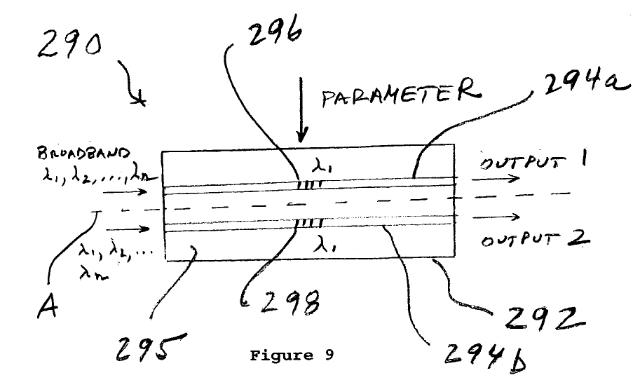

### FIG. 9: Multi-Core Sensing Device

FIG. 9 shows a multi-core sensing device generally indicated as 290 that includes a large diameter optical waveguide 292 having two inner cores 294a, 294b, a cladding 295 surrounding the same, and two long period gratings 296, 298 having a given wavelength such as λ₁. The two inner cores 294a, 294b are arranged in relation to an axis A of the large diameter optical waveguide 292, preferably symmetrically. A broadband optical signal having wavelengths such as λ₁, λ₂, . . . , λₙ is provided into the two inner cores 294a, 294b. In operation, in response to some parameter, the large diameter optical waveguide 292 will be perturbed by compressing or bending changing the optical characteristics of the two long period gratings 296, 298, and the output signals will have a notch at the wavelength λ₁. The change in the optical characteristics of the two long period gratings 296, 298 are not identical, and the difference between the two is used to determine or sense the parameter. In other words, the multi-core sensing device 290 can also be made to form sensors by exploiting the differential shift the transmission notch of each long period grating 296, 298 caused by bending the waveguide. The deflection would cause the strength and wavelength range of the long period grating 296, 298 in each of the cores 294a, 294b to react in a non-uniform fashion. In an alternative embodiment, each core may contain a pair of long period gratings.

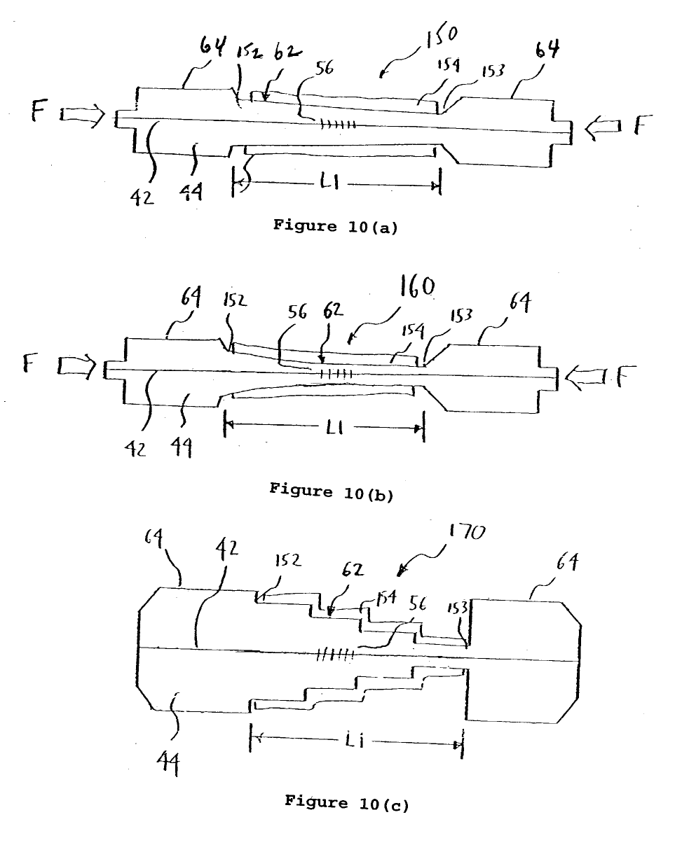

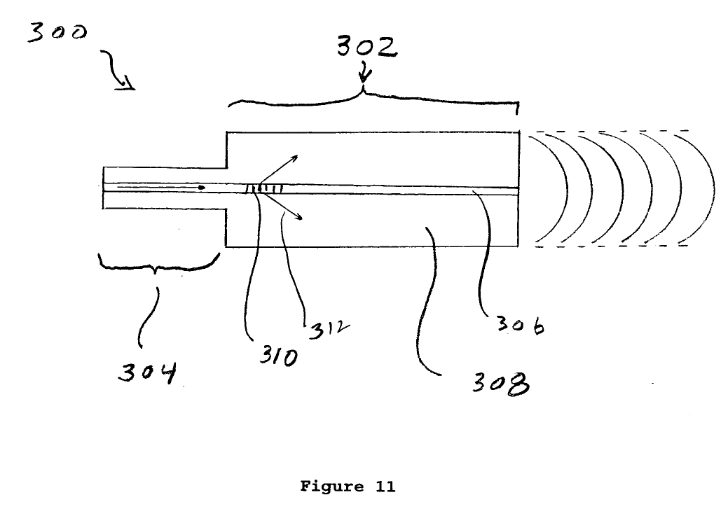

### FIGS. 10a, 10b, 10c: Tapered Cane Structure Designs

FIGS. 10a, 10b, 10c show tapered cane design structures that may be used in combination with the long period grating design of the present invention.

In particular, the diameter d3 of the narrower central section 62 of the large diameter optical waveguide 40 shown in FIG. 2a is narrower than the diameter d4 of the two wider outer sections 64. With the arrangement as shown in FIG. 2a, when an axial compressive force F is exerted at the ends of the large diameter optical waveguide 40, the axial force applied to the narrower central section 62 is magnified by the mechanical advantage provided by the geometry of the cladding 44. More specifically, the axial force exerted onto the narrower central section 62 is effectively magnified by a factor substantially equal to the ratio of the cross-section of the wider outer sections 64 to the cross section of the narrower central section 62. This geometry renders it practical to compression-tune the grating gain filter with high precision. If the cross-section of the narrower central section 62 of the large diameter optical waveguide 40 is uniform throughout the narrower central section containing the grating(s) 56, then the shape of a given grating profile will remain substantially the same while the central wavelength (or reflection wavelength ë_{B}) of the given grating profile shifts.

In some occasions, however, it may be desirable to change statically or dynamically the shape of the given grating profile. As shown in FIGS. 10a, 10b, 10c, this may be accomplished by varying the cross-sectional area of the central section of the large diameter waveguide 150, 160, 170 along its length L1.

### FIG. 10a: Linear Taper

FIG. 10a shows how the narrower central section 62 of the large diameter waveguide 150 may be linearly tapered, such that a first end 152 of the narrower central section 62 is wider than a second end 153. Accordingly, when the large diameter waveguide 150 is compressed by an axial force F, the long period grating 56 is linearly chirped, and thereby changes the shape of the given grating profile, accordingly. Additionally, a thermal device 154 (e.g., heater TEC or any heating or cooling device) may be wrapped around the narrower central section 62 of the large diameter waveguide 150 to tune the center wavelength of the long period grating 56 along a desired spectral range.

### FIG. 10b: Quadradically Taper

FIG. 10b shows how the narrower central section 62 of the large diameter waveguide 160 may be quadradically tapered, such that a first end 152 of the narrower central section 62 is wider than a second end 153. Accordingly, when the waveguide 160 is compressed by an axial force F, the long period grating 56 is quadradically chirped, and thereby changes the shape of the given grating profile of the long period grating 56 accordingly. Similarly, the thermal device 154 may be wrapped around the narrower central section 62 of the large diameter waveguide 160 to tune the center (or reflection) wavelength of the long period grating 56 along a desired spectral range.

### FIG. 10c: Step-Like Taper

FIG. 10c shows how the narrower central section 62 of the waveguide 170 may be tapered in a stepped fashion, such that a first end 152 of the narrower central section 62 is wider than a second end 153. Accordingly, when the waveguide 170 is compressed by an axial force F, the long period grating 56 is linearly tuned at discrete locations along the narrower central section 62, and thereby changes the shape of the given grating profile accordingly. Similarly, the thermal device 154 may be wrapped around the narrower central section 62 of the waveguide 170 to tune the center (or reflection) wavelength of the long period grating along a desired spectral range.

### FIG. 11: The Collimator

FIG. 11 shows a collimator generally indicated as 300 having the basic features of the present invention. The collimator 300 includes a large diameter waveguide generally indicated as 302, similar to that discussed above, coupled to or integral with an optical fiber generally indicated as 304. As discussed above, the large diameter optical waveguide 302 has a diameter of at least about 0.3 millimeters, and the optical fiber has a typical diameter of about 125 microns. As discussed above, the collimator 300 may be formed by a collapsed glass technique in which a glass tube is fused and collapsed over an optical fiber, as disclosed in the patent applications referenced above. The coupling of the optical fiber and the large diameter waveguide may also be accomplished by fusing and/or epoxy or other adhesive type material. In this case, the optical fiber 304 is a remaining pigtail extending from the resulting large diameter waveguide 302. There are other ways to couple a large diameter waveguide to an optical fiber disclosed in the one or more of the patent applications referenced above, and the scope of the invention is not intended to be limited to any particular way of coupling these optical components together.

The collimator 300 has a core 306 surrounded by a cladding 308. The core 306 has a long period grating 310 formed therein. The long period grating 310 is formed in a portion of the core 306 in the large diameter waveguide 302, which provides the necessary structural rigidity discussed above. The scope of the invention is also intended to include embodiments in which the long period grating 310 is formed in both the core 306 and the cladding 308, consistent with that discussed above.

In operation, the long period grating 310 couples light travelling in the core 306 to the cladding 308, as generally indicated by the light rays 312. In effect, the inventors have provided a fiber with locally a very large diameter cladding. In the location with the increased cladding diameter the long period grating is written to couple light into one of the lower order modes of the glass rod. Light exiting the cladding 308 of the large diameter waveguide 302 in a low order mode should have very small divergence, when compared to the divergence of light if it were to exit the core 306, as is known in the prior art.

The collimator 300 could be easy to manufacture and stable over a large temperature range.

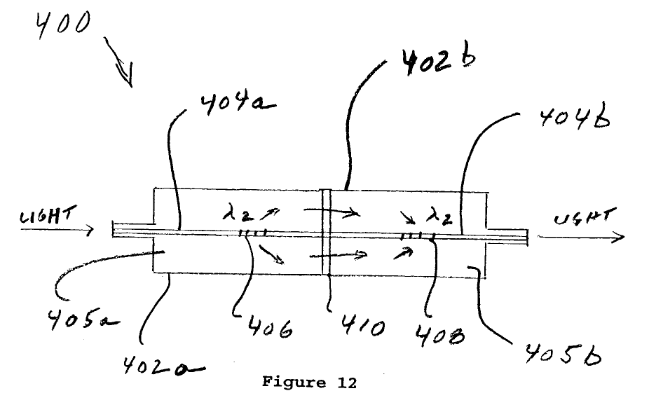

### FIG. 12: The Connector

FIG. 12 shows a connector generally indicated as 400, including large diameter optical waveguides 402a, 402b having inner cores 404a, 404b, claddings 405a, 405b surrounding each of the same, two long period gratings 406, 408 having a given wavelength such as λ₂, and epoxy 410 or other means for mechanically fusing or connecting the waveguide. Although the embodiment disclosed herein has the two waveguides mechanically coupled, an embodiment is also envisioned in which the two waveguides are not coupled and a free optics arrangement is used instead. The objects of this invention is to include the provisions of an optic connector which require reduced mechanical tolerances yet maintains the ability to provide efficient cane to cane power coupling. The coupling technique is independent of cane parameters such as core concentricity and mode field diameter.

The basis for this invention is an optic connection technique whereby two long period gratings are used to efficiently couple light from the core of one cane to the core of another cane via the cane cladding. The design of the connector is based on a long period grating. Long period gratings can be optically “written” into the core of a cane through the use of masks or other interferometric techniques. A long period grating written with the proper periodicity and strength is positioned and epoxied into a connector as shown in FIG. 11. Light traveling down the core 404a, 404b is resonantly coupled to a single cladding mode. The specific cladding mode can be varied by adjusting the design parameters of the long period gratings 406, 408. Shorter periodicity of the grating will couple to a higher cladding mode at a given wavelength. Preservation of the cladding mode is maintained by ensuring the cane is held straight in the connector 400 and a low index epoxy is used to secure the connection. Low index epoxies are not necessary if low order cladding modes are gene-rated and the separation between the rating is kept short. The cane 402b into which the light is being coupled (i.e. the receiving cane) is aligned and brought into physical contact with the first cane 402a (i.e. transmitting cane). This receiving cane 402b also contains a matching long period grating.

Light traveling down the core of the transmitting cane 402a encounters the grating and is ejected from the core to a discrete cladding mode just prior to the end of the epoxy 410. The light is then coupled from the transmitting cane 402a to the receiving cane 402b via the cladding of the two canes 402a, 402b. Once in the receiving cane 402b, the cladding light encounters the second grating 408 whereby it is resonantly re-injected into the core 404b. Because this process relies on coupling between the cladding of the two canes 402a, 402b as opposed to the cores, the mechanical tolerances of the mating parts can be relaxed.

The long period grating connection technique can be used to efficiently couple light between many different optical components, including two dissimilar optical fibers. Typically, dissimilar fibers undergo excess loss due to mode mismatch between the cores. This connection technique can minimize this loss because the light traveling between the canes 402a, 402b at the connection point is in the cladding, which is typically undoped Fused Quartz. The grating period would be optimized on each cane to excite the same cladding mode, thereby making the cane to cane coupling independent of the core parameters.

The long period grating connector could also be configured as an adjustable fiber attenuator. Generation of an asymmetric cladding mode by the grating will result in a cane to cane connection efficiency that will be orientation dependent. Rotation of one cane relative to the other, around the axis defined by the cane, will result in the coupling efficiency to vary between a maximum and minimum value. A continuous range of attenuations could be selected.

This invention provides a solution to a well known problem in the art. It is well known in the field of fiber optics that the mating between two singlemode fibers requires a connection system that can align the cores of the respective fibers to within fractions of the core diameter. This requirement necessitates that the mating parts to be fabricated with a high degree of mechanical precision. The two major connection methods used today to yield efficient fiber to fiber coupling are butt coupled and expanded beam connectors.

The butt-coupled technique typically utilizes a ferrule machined to very high tolerances into which the one of the fibers is held with epoxy. The end of the fiber is polished and mated to an opposing ferrule containing the second fiber. A precision sleeve maintains the alignment of the respective fibers. The insertion loss of these connections is dependent upon the concentricity of the inner diameter hole to the ferrule outer diameter, the inner diameter hole size relative to the fiber outside diameter, and the outside diameter of the ferrule relative to the inside diameter of the sleeve.

Expanded beam connectors use discrete optics to reduce the lateral sensitivity of the alignment at the expense of increasing the angular sensitivity. This technique typically collimates the output of the fiber by aligning the fiber to lens. The opposing half of the connector captures and refocuses the light into the core of the receiving fiber. To achieve high coupling efficiency with these connectors, stable alignment of the fiber endface to the ball lens and minimal angular misalignment is required. The ball lenses are typically fabricated out of high index glasses to reduce aberrations, which leads to the requirement of antireflection coatings to reduce reflections.

Thus, the cane-to-cane coupling technique provides an optical connector which overcomes the drawbacks of precision part tolerances as well as the need for optical coatings.

### The Scope of the Invention

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

For example, although the invention is described in relation to long period gratings, the inventors envision other embodiments using blazed gratings, periodic or aperiodic gratings, or chirped gratings.

Although the invention has been described and illustrated with respect to exemplary embodiments thereof, the foregoing and various other additions and omissions may be made therein without departing from the spirit and scope of the present invention.

What is claimed is:

1. A large diameter optical waveguide having a diameter of at least about 0.3 millimeters, and having an outer cladding surrounding an inner core with a long period grating therein.

2. A large diameter waveguide according to claim 1, wherein the long period grating either couples forward propagating cores modes to forward propagating cladding modes of one optical signal travelling in one direction in the large diameter waveguide, or couples forward propagating cladding modes to forward propagating cores modes of another optical signal travelling in another direction in the large diameter waveguide.

3. A large diameter waveguide according to claim 1, wherein the long period grating has an optical parameter that changes in response to the application of a compressive force on the optical waveguide.

4. A large diameter waveguide according to claim 1, wherein either the inner core has the long period grating written therein, or the cladding has the long period grating written therein, or a combination of the inner core and the cladding has the long period grating therein.

5. A large diameter waveguide according to claim 1, wherein the long period grating includes a plurality of concatenated gratings.

6. A large diameter waveguide according to claim 1, wherein the optical waveguide is shaped like a dogbone structure having wider outer sections and a narrower central section inbetween.

7. A large diameter waveguide according to claim 6, wherein the long period grating is written in the narrower central section of the dogbone structure.

8. A large diameter waveguide according to claim 7, wherein the narrower central section has a tapered shape.

9. A large diameter waveguide according to claim 8, wherein the tapered shape is linear.

10. A large diameter waveguide according to claim 8, wherein the tapered shape is quadratic.

11. A large diameter waveguide according to claim 8, wherein the tapered shape has a step-like shape.

12. A large diameter waveguide according to claim 6, wherein the narrower intermediate section has a thermal device wrapped around the narrower central section of the optical waveguide to tune the center wavelength of the long period grating along a desired spectral range.

13. A large diameter waveguide according to claim 1, wherein the inner core has a pair of long period gratings therein separated by a distance to provide out-coupling of the fundamental mode to cladding mode by a first long period grating followed by in-coupling of the cladding mode to fundamental mode by a second long period grating.

14. A large diameter waveguide according to claim 13, wherein the pair of long period gratings have a core block arranged inbetween so that all that are not coupled would be scattered.

15. A large diameter waveguide according to claim 13, wherein the large diameter waveguide forms a bandpass filter that passes only a selected band of wavelengths.

16. A large diameter waveguide according to claim 15, wherein the bandpass filter is tunable using a compression tuning technique.

17. A large diameter waveguide according to claim 1, wherein the large diameter waveguide forms a part of a collimator that couples light from a fundamental core mode into a low order cladding mode for providing a light beam with a small divergence.

18. A large diameter waveguide according to claim 1, wherein the long period grating has a periodicity in a range of about 20-900 microns.
